(19) United States
(12) Patent Application Publication
(10) Pub. No.: US 2004/0078433 A1
(43) Pub. Date: Apr. 22, 2004

(54) Electronic mail retrieval and notice system for cellular phones

(76) Inventors: Cheng-Shing Lai, Taipei Hsien (TW); Chang Liu, Nanjing (CN)

Correspondence Address: NAIPO (NORTH AMERICA INTERNATIONAL PATENT OFFICE), P.O. BOX 506, MERRIFIELD, VA, 22116, US

(21) Appl. No.: 10/065,434

(22) Filed: Oct. 17, 2002

(51) Int. Cl. G06F 15/16

(52) U.S. Cl. 709/206

(57) ABSTRACT

An electronic mail retrieval and notice system for cellular phones. The electronic mail retrieval and notice system comprises a mail service subsystem for retrieving e-mails to generate retrieval information, and a wireless communication subsystem for receiving and transmitting radio signals. When an e-mail is sent to an e-mail box of a user, the mail service subsystem retrieves the e-mail according to an index so as to determine whether to generate retrieval information, and after the retrieval information is generated, the wireless communication subsystem wirelessly transmits the retrieval information to a cellular phone, which is assigned by the user, so that the cellular phone can display the retrieval information.

### BACKGROUND OF INVENTION

1. Field of the Invention

The present invention relates to an e-mail retrieval and notice system. More particularly, the present invention relates to an e-mail retrieval and notice system capable of informing a cellular phone user about the arrival of important mail messages through sending phone messages.

2. Description of the Prior Art

Recently, there have been more and more cellular phones that provide the function of sending or receiving electronic mails (e-mails). The cellular phone users are now able to remotely receive their e-mails from the e-mail servers. To read e-mails, a cellular phone user has to turn on his or her cellular phone in the first place. Thereafter, the cellular phone will connect with the e-mail server and then download all the e-mails stored on the e-mail server. However, there is a problem in that the cellular phone user does not know what kind of or how many of e-mails he or she is going to deal with after the cellular phone is turned on. Sometimes, many of these received e-mails are advertisement e-mails or “junk e-mails”, and it is not worth spending time to download these messages. Meanwhile, the current system does not provide a real time notice function for informing a cellular phone user upon the arrival of an important e-mail. In view of this, there is a strong need to provide the cellular phone users with a notice function, in which retrieval information is included, such that the cellular phone users can decide whether or not to download the e-mails.

### SUMMARY OF INVENTION

Accordingly, the main objective of the invention is to provide a novel e-mail retrieval and notice system for cellular phones to solve the above-mentioned problems.

According to the claimed invention, an electronic mail retrieval and notice system for cellular phones is provided. The electronic mail retrieval and notice system comprises a mail service subsystem for retrieving e-mails to generate retrieval information, and a wireless communication subsystem for receiving and transmitting radio signals. When an e-mail is sent to an e-mail box of a user, the mail service subsystem retrieves the e-mail according to an index so as to determine whether to generate retrieval information, and after the retrieval information is generated, the wireless communication subsystem wirelessly transmits the retrieval information to a cellular phone, which is assigned by the user, so that the cellular phone can display the retrieval information.

It is advantageous to use the claimed invention because users can adjust the index according to different needs. After setting the contents of an index, every new e-mail that corresponds with the settings of the index will automatically transmitted to the mail box assigned by the user. Thereafter, the e-mail retrieval and notice system retrieves these new e-mails and generates associated retrieval information, which are then transmitted to an assigned cellular phone by way of message format, such that the cellular phone user is notified in time.

Other objects and novel features of the claimed invention will become more clearly and readily apparent from the following detailed description when taken in conjunction with the accompanying drawings.

### BRIEF DESCRIPTION OF DRAWINGS

FIG. 1 is a functional block diagram schematically showing the electronic mail retrieval and notice system and related devices according to the present invention.

FIG. 2 is a functional block diagram illustrating a cellular phone of FIG. 1.

FIG. 3 is a flowchart regarding the operation of a mail service subsystem of FIG. 1.

FIG. 4 is a flowchart depicting the process of the cellular phone of FIG. 1 when dealing with retrieval information.

FIG. 5 is a flowchart depicting the process of the cellular phone of FIG. 1 when dealing with stored (or waived) retrieval information, which has been read by a cellular phone user, but was not handled immediately.

### DETAILED DESCRIPTION

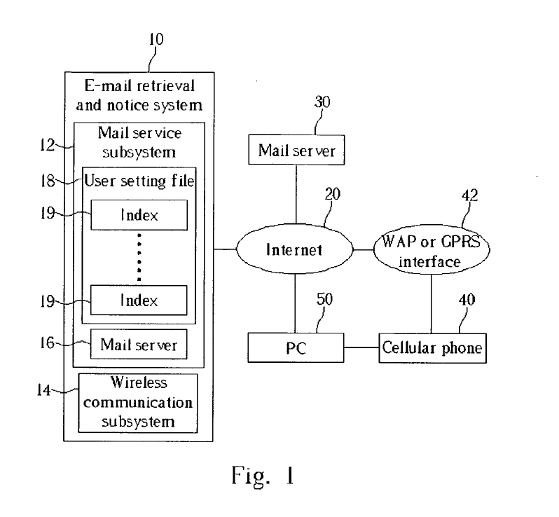

Please refer to FIG. 1. FIG. 1 is a functional block diagram schematically showing the electronic mail retrieval and notice system 10 and related devices according to the present invention. The electronic mail retrieval and notice system 10 comprises a mail service subsystem 12 and a wireless communication subsystem 14. The mail service subsystem 12 comprises a mail server 16 for receiving or sending e-mails, and a user setting file 18 for recording a plurality of indices 19. The wireless communication subsystem 14 is capable of communicating with other remote wireless devices by way of radio frequency. The electronic mail retrieval and notice system 10 connects to a mail server 30, a cellular phone 40, and a computer 50 through an Internet 20. Between the Internet 20 and the cellular phone 40 is a Wireless Application Protocol (WAP) interface or a General Packet Radio Service (GPRS) interface 42. Through the interface 42, the cellular phone 40 can connect to the Internet 20, thereby establishing communication with other devices, which connect with the Internet 20.

The mail server 16 of the mail service subsystem 12 comprises a plurality of e-mail boxes for managing e-mails of different users. Each of the indices 19 of the user setting file 18 corresponds to an e-mail box of the mail server 16. When an e-mail is sent to an e-mail box of a user, the mail service subsystem 12 retrieves the e-mail according to an associated index 19 so as to determine whether to generate retrieval information. The contents of the index 19 is determined by the user. For instance, a user can use his cellular phone 40 or computer 50 to initialize or adjust the contents of the corresponding index 19. Each of the indices 19 may comprise sender names, sender addresses, mailing date/time, mail subjects, or key words created by the user. When a new e-mail complies with the settings of an index 19, the mail service subsystem 12 generates a corresponding retrieval message, which is subsequently transmitted to a specific cellular phone associated with the index 19 by the wireless communication subsystem 14. In few seconds, the cellular phone 40 will display the retrieval message showing basic information about the newly arrival e-mail. It is noted that the contents of the retrieval message can be adjusted by the user. The mail service subsystem 12 automatically creates the retrieval message by extracting associated information according to user's settings.

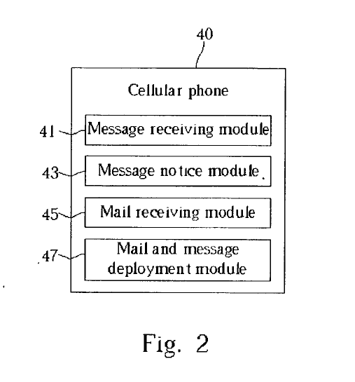

Please refer to FIG. 2. FIG. 2 is a functional block diagram illustrating the cellular phone 40 of FIG. 1. The cellular phone 40 comprises a message receiving module 41, a message notice module 43, a mail receiving module 45, and a mail and message deployment module 47. The message receiving module 41 is used to receive the message containing retrieval information transmitted from the wireless communication subsystem 14. The message notice module 43 is used to display the retrieval information. The mail receiving module 45 is used to receive e-mails transmitted from the wireless communication subsystem 14. The mail and message deployment module 47 allows a user to adjust settings such as mail servers, mail account, etc. Furthermore, the user is able to adjust the associated index 19 of the mail service subsystem 12 through the mail and message deployment module 47.

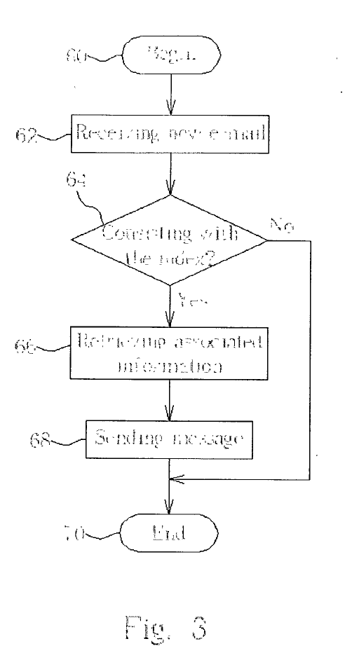

Please refer to FIG. 3. FIG. 3 is a flowchart regarding the operation of the mail service subsystem 12 of FIG. 1. When the mail server 16 receives an e-mail (step 62), the mail server 16 will begin to search the user setting file 18 for an index 19 that corresponds with the receiver of this e-mail, and then retrieve the e-mail according to the information of the index 19 so as to determine whether to generate retrieval information (step 64). If the e-mail corresponds with the settings of the index 19, the mail service subsystem 12 subsequently creates retrieval information by extracting information of the e-mail according to the settings of the user (step 66). If the new e-mail does not correspond with the settings of the index 19, the checking process of the mail service subsystem 12 is then terminated (step 70). After the retrieval information is generated, the wireless communication subsystem 14 wirelessly transmits the retrieval information to a pre-selected cellular phone, which is assigned by the user (step 68), so that the cellular phone can display the retrieval information.

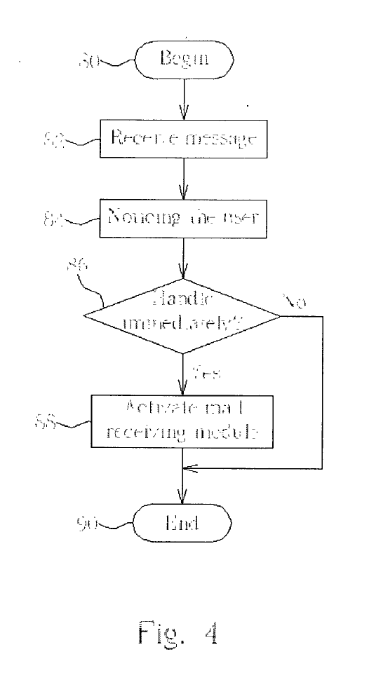

Please refer to FIG. 4 with reference to FIG. 3. FIG. 4 is a flowchart depicting the process of the cellular phone 40 of FIG. 1 when dealing with the retrieval information. When the wireless communication subsystem 14 sends a message including retrieval information, the cellular phone 40 activates message receiving module 41 to receive the message (step 82). Following this, the cellular phone 40 then activates the message notice module 43 to notice the cellular phone user by displaying the retrieval information of this message (step 84). After the cellular phone user looks over the displayed retrieval information, he or she can then immediately decide how to deal with this message: download the new e-mail or leave it (step 86). If the cellular phone user decides to handle this message immediately, he or she can use the cellular phone at hand to activate the mail receiving module 45 (step 88), which will transmit a request according to a mail identity code of the retrieval information to the mail service subsystem 12 through the wireless communication subsystem 14. After receiving the request, the mail service subsystem 12 will transmit the e-mail corresponding to the retrieval information to the cellular phone 40 through the wireless communication subsystem 14. If the cellular phone user decides not to handle this message, then the message will be stored in the cellular phone, and the process is terminated (step 90).

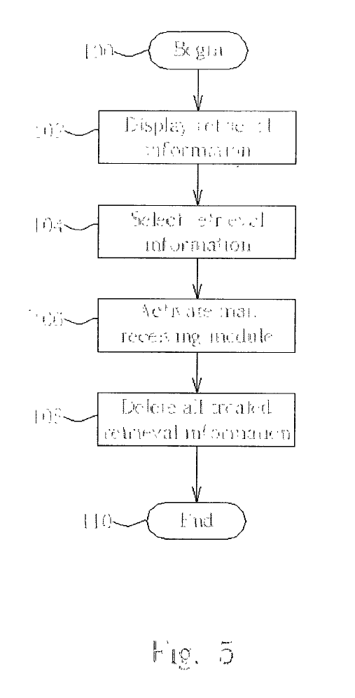

Please refer to FIG. 5 with reference to FIG. 3. FIG. 5 is a flowchart depicting the process of the cellular phone 40 of FIG. 1 when dealing with the stored (or waived) retrieval information, which has been read by the cellular phone user, but was not handled immediately. The cellular phone user does not download an e-mail after he she read an associated retrieval information, instead, he or she decides to read this e-mail some time later. In this case, the cellular phone user can use the cellular phone 40 to activate the message notice module 43 to display all retrieval information items, which are not handled (step 102). Thereafter, the cellular phone user can select a particular retrieval information item and download corresponding e-mail (step 104). After the user selects a retrieval information item, the mail receiving module 45 of the cellular phone 40 is activated so that the mail service subsystem 12 can transmit an e-mail corresponding to a selected retrieval information item to the cellular phone through the wireless communication subsystem 14 (step 106). After the cellular phone 40 receives the e-mail corresponding to a selected retrieval information item, the selected retrieval information item is deleted (step 108), thereby terminating the process (step 110).

In the above-described embodiment of this invention, a preferred example of retrieving new e-mails stored in the mail server 16 of the mail service subsystem 12 is proposed. It is understood that, in another case, the present invention is also suited for retrieving e-mails stored in an “outer” mail server. With reference to FIG. 1, the e-mail retrieval and notice system 10 is connected to an outer mail server 30 through the Internet 20. The mail service subsystem 12 may retrieve new e-mails of the mail server 30 through the Internet 20. In this case, the mail service subsystem 12 downloads the e-mails stored at the mail server 30, and then implements the action of retrieving these new e-mails. To properly download the e-mails stored at the mail, server 30 to the mail service subsystem 12, the cellular phone user has to input the mail account and related password into the user setting file 18 in advance. With this configuration, the mail service subsystem 12 can download the e-mails from the mail service 30 at intervals such as 30 minutes, and thereafter, retrieve these downloaded e-mails according to a user's settings of an index 19 so as to determine whether to generate retrieval information. As mentioned, when the retrieval information is generated, it is transmitted to the cellular phone assigned by the user. In still another case according to this invention, the mail service subsystem 12 may transmit the index 19, the user's mail account, and the password to the mail server 30. The mail server 30 may retrieve new e-mails stored in the user's account according to a user's settings of the index 19 so as to determine whether to generate retrieval information. The retrieval information generated by the mail server 30 may be transmitted to the cellular phone 40 assigned by the user through the mail service subsystem 12 and the wireless communication subsystem 14.

Furthermore, the cellular phone 40 may connect with a computer 50. When the cellular phone 40 receives messages or e-mails from the wireless communication subsystem 14, these messages or e-mails can be transmitted to the computer 50, such that the computer 50 and the cellular phone 40 can synchronically deal with these downloaded messages or e-mails.

To sum up, in accordance with the present invention, a mail service subsystem or an outer mail server retrieves a new e-mail upon its arrival according to a user's settings of an index so as to determine whether to generate corresponding retrieval information. After setting the contents of an index, every new e-mail that corresponds with the settings of the index will automatically be transmitted to the mail box assigned by the user. Thereafter, the e-mail retrieval and notice system generates associated retrieval information, which is then transmitted to an assigned cellular phone by way of message format, such that the cellular phone user is notified in time and selectively downloads the important e-mails timely.

Those skilled in the art will readily observe that numerous modification and alterations of the device may be made while retaining the teachings of the invention. Accordingly, the above disclosure should be construed as limited only by the metes and bounds of the appended claims.

What is claimed is:

1. An electronic mail retrieval and notice system for cellular phones, comprising:
a mail service subsystem for retrieving e-mails to generate retrieval information; and
a wireless communication subsystem for receiving and transmitting radio signals;
wherein when an e-mail is sent to an e-mail box of a user, the mail service subsystem retrieves the e-mail according to an index so as to determine whether to generate retrieval information, and after the retrieval information is generated, the wireless communication subsystem wirelessly transmits the retrieval information to a cellular phone, which is assigned by the user, so that the cellular phone can display the retrieval information.

2. The electronic mail retrieval and notice system of claim 1 wherein when the cellular phone displays the retrieval information, the user can use the cellular phone to transmit a request associated with the retrieval information to the electronic mail retrieval and notice system so as to transmit the e-mail to the cellular phone via the wireless communication subsystem.

3. The electronic mail retrieval and notice system of claim 1 wherein the mail service subsystem comprises a user setting file for storing settings of a plurality of users and the index is recorded in the user setting file, and the mail service subsystem retrieves e-mails of the users according to the user setting file, thereby generating proper retrieval information and then transmitting the retrieval information to corresponding cellular phones via the wireless communication subsystem.

4. The electronic mail retrieval and notice system of claim 1 wherein the index comprises sender name, sender address, mailing date/time, mail subject, or key words created by the user.

5. The electronic mail retrieval and notice system of claim 1 wherein the user can use the cellular phone to adjust the content of the index.

6. The electronic mail retrieval and notice system of claim 1 wherein the user can use a computer to adjust the content of the index.
